(19) United States
(12) Patent Application Publication
(10) Pub. No.: US 2026/0341746 A1
(43) Pub. Date: Oct. 29, 2026

(54) ONE-PIECE ELECTRICAL CONDUCTOR

(71) Applicant: COMMISSARIAT A L'ENERGIE ATOMIQUE ET AUX ENERGIES ALTERNATIVES, Paris (FR)

(72) Inventors: Michel PLANQUE, Grenoble Cedex 09 (FR); Simon ALAMOME, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/135,155

(22) PCT Filed: Dec. 1, 2023
(86) PCT No.: PCT/FR2023/051895

§ 371 Date: Jun. 3, 2025

(30) Foreign Application Priority Data
Dec. 5, 2022 (FR) FR2212768

(51) Int. Cl. H01M 8/021; H01B 1/02; H01B 13/00; H01B 13/004; H01M 8/12; H01M 8/2425

(52) U.S. Cl. CPC H01M 8/021; H01B 1/026; H01B 13/0016; H01B 13/004; H01M 8/12; H01M 8/2425; H01M 2008/1293

(57) ABSTRACT

The main object of the invention is an electrical conductor (70) comprising: an assembly (72) comprising a main conductive core (74) made of a first metal material and a sheath (79) covering the main conductive core (74) and made of a second metal material, with an electrical resistivity greater than the electrical resistivity of the first metal material; a connection pin (78) connected to a first end (72a) of the assembly (72), comprising a conductive core of the connection pin and a protective housing of the connection pin, characterized in that the connection pin (78) is at least partly made of the second metal material, and in that the conductive core of the connection pin (73) and the main conductive core (74) are made of a single piece.

### TECHNICAL FIELD

The present invention relates to the general field of High Temperature Electrolysis (HTE), in particular High Temperature Steam Electrolysis (HTSE), carbon dioxide (CO₂) electrolysis, and even high temperature co-electrolysis of steam and carbon dioxide (CO₂).

More specifically, the invention relates to the field of high-temperature electrochemical devices, such as Solid Oxide Electrolysis Cells, usually referred to by the acronym SOEC, and high-temperature Solid Oxide Fuel Cells, usually referred to by the acronym SOFC, but also high-temperature co-electrolyzers of steam with carbon dioxide, high-temperature electrolyzer and reversible fuel cell systems, or so-called medium-temperature fuel cells or electrolyzers, of around 400 °C, also known as PCFC for Proton Ceramic Fuel Cells.

Thus, more generally, the invention relates to the field of solid oxide cell stacks of the SOEC/SOFC type operating at high temperature. These stacks can operate at atmospheric pressure or under pressure.

Beyond such SOEC/SOFC type solid oxide cell stacks, the invention relates to any system where there is a need for electrical conduction in oxidizing environment at high temperature or under conditions leading to rapid degradation of electrically conductive materials.

More particularly, the invention relates to the supply of electric current to a stack of electrochemical cells in the hot zone.

### PRIOR ART

In the context of a high-temperature solid oxide electrolysis cell (SOEC), it involves converting steam (H₂O) into dihydrogen (H₂), or other fuels such as methane (CH₄), natural gas, biogas, and dioxygen (O₂), by means of an electric current and within the same electrochemical device, and/or converting carbon dioxide (CO₂) into carbon monoxide (CO) and dioxygen (O₂). In the context of a high-temperature solid oxide fuel cell (SOFC), the operation is reversed to produce electric current and heat by being supplied with dihydrogen (H₂) and dioxygen (O₂), typically in air and natural gas, namely by methane (CH₄). For simplicity, the following description favors the operation of a high-temperature solid oxide electrolysis cell (SOEC) performing the electrolysis of steam. However, this operation is applicable to the electrolysis of carbon dioxide (CO₂), and even to the high temperature co-electrolysis of steam (HTSE) with carbon dioxide (CO₂). In addition, this operation is transposable in the case of a high-temperature solid oxide fuel cell (SOFC).

As is known in itself, a high-temperature steam (H₂O) electrolyzer, or HTSE electrolyzer, comprises a stack of several elemental solid oxide electrochemical cells. Referring to FIG. 1, a solid oxide cell 10, or “SOC” (Solid Oxide Cell) comprises in particular: a) a first porous conductive electrode 12, or cathode, designed to be supplied with steam for the production of dihydrogen; b) a second porous conductive electrode 14, or anode, through which the dioxygen (O₂) produced by the electrolysis of the water injected onto the cathode escapes; and c) a solid oxide (dense electrolyte) membrane 16 sandwiched between the cathode 12 and the anode 14, the membrane 16 being anion conductive for high temperatures, usually temperatures above 600 °C.

By heating the cell 10 at least to this temperature and injecting an electric current/to the anode 14, a reduction of the water on the cathode 12 then occurs, which generates dihydrogen (H₂) at the cathode 12 and dioxygen (O₂) at the anode 14.

A stack 20 of such cells, aimed at producing a significant amount of hydrogen, is illustrated by the schematic view of FIG. 2. In particular, the cells 10 are stacked on top of each other, separated by interconnection plates 18 or interconnectors. The function of these plates is both to ensure electrical continuity between the different electrodes of the cells 10, thus allowing them to be electrically connected in series, and to distribute the different gases necessary for the functioning of the cells, as well as, where applicable, a carrier gas to help evacuate the electrolysis products and/or thermally manage the stack.

To do this, the plates 18 are connected to a steam supply 22 for injecting this steam onto the cathodes of the cells 10 in accordance with a constant steam flow D_{H2O} adjusted by a controllable valve 24. The plates 18 are also connected to a gas manifold 26 for collecting the gases from the electrolysis. An example of an interconnection plate stack and structure is for example described in international application WO 2011/110676 A1.

For the effective implementation of the electrolysis by the stack 20, the stack is brought to a temperature above 600 °C, usually a temperature between 650 °C and 900 °C, the gas supply is switched on at a constant flow rate, and an electrical supply source 28 is connected between two terminals 30, 32 of the stack 20 in order to circulate a current/therein.

The intensity/of the electric current is usually around a few hundred amps, which generates significant heat losses by Joule effect in the electrical conductors. In order to optimize the energy efficiency of solid oxide electrochemical systems, these heat losses should be limited specifically by developing electrical conductors, also referred to as “current-carrying conductors” (or “busbars”).

A current-carrying conductor in the stack is usually in the form of a metal rod. Taking the example of a cylindrical rod, the electrical resistance R is expressed by the following formula:

$$R = ρ \cdot \frac{l}{S}$$

where ρ is the rod resistivity (in Ω·m), L is the rod length (in m) and S is the rod cross-section (in m²).

As the losses by Joule effect are proportional to the resistance, Rto limit this effect, it is therefore necessary to reduce the electrical resistance of the current-carrying conductor. The possible optimizations therefore consist of:
limiting the length of the rod,
increasing its cross section,
finding a material with a lower resistivity and stable at high temperature.

The first two possibilities are geometry choices that generally depend on the shape of the electrochemical system. Therefore, there are constraints concerning them and/or the conductors of the prior art are already optimized with respect to the electrochemical system. The last point concerns the rod material to be chosen with minimum resistivity to reduce ohmic loss.

The optimization of this last point has not been sufficiently taken into account. Indeed, energy efficiency is not paramount for all laboratory developments of technology. On the other hand, as explained below, a current-carrying conductor is bathed in a highly corrosive environment, so the standard solution implemented is to use solid stainless alloy rods, which are therefore the reference solution in all international publications. While the resistivity at ambient temperature (20 °C) of these rods is already high, around 75.10⁻⁸ Ω·m, it should be known that this resistivity increases sharply with temperature.

Thus, at 900 °C, which is a high temperature for functioning of a solid oxide electrolysis cell, the electrical resistance of a stainless steel rod is equal to 117. 10⁻⁸ Ω·m, which generates a very high ohmic loss. These aspects were particularly described in the French patent application FR 3 036 840 A1.

However, in order to optimize electrical resistivity, copper is generally the recommended material for electrical conductors subjected to a high current intensity. An experimental study carried out by the Applicant made it possible to determine the resistivity curve of copper as a function of temperature and to confirm that the choice of copper makes it possible to reduce the ohmic loss relative to the reference material by a factor of at least 10 over the entire operating temperature range of the solid oxide systems.

However, one of the strong constraints that needs to be taken into consideration is the problem of corrosion related to the stack environment.

Referring to FIG. 3, the stack 20 is indeed enclosed in a so-called “thermal” enclosure, the temperature of which is maintained between 65° and 900 °C under air flush, a conventional electrochemical system thus comprising:
the HTSE electrolyzer 20, for example that described in relation to FIGS. 1 and 2 and comprising a set of pipes 52, 54, 56, 58 for supplying and collecting the gases of the anodes and cathodes of the electrochemical cells of the electrolyzer;
an enclosure 60 in which the electrolyzer 20 is housed, the pipes 52, 54, 56, 58 passing through a wall of the enclosure 60 for their connection to gas supply and collection circuits (not shown). The enclosure 60 also includes an air inlet duct 62, and an air outlet duct 64, the enclosure 60 being for example everywhere else sealed to gases and liquids. The duct 62 is capable of being connected to an air supply circuit (not shown) so as to apply an air flush of the hot zone surrounding the electrolyzer 20, the flush air being evacuated by the outlet duct 64; and
two electrical conductors 66, 68 connected to the terminals 30, 32 of the stack 20 and passing through the enclosure 60 for their connection to the current source 28.

Under these conditions, two conductors 66, 68 in the form of a copper rod, at least part of which is included in the enclosure 60, will oxidize very quickly. In addition, copper is not resistant to oxidation at high temperatures because the oxide formed on the surface is not sufficiently sealed and adherent to protect the underlying metal. Materials known to resist oxidation at high temperature are forming chromine and alumina alloys such as stainless steels and stainless nickel alloys because these form chromine and/or alumina which are much more protective oxides. However, as mentioned above, these alloys have an electrical resistivity such that their use results in significant energy loss.

A high temperature solid oxide fuel cell (SOFC) has similar problems. Indeed, an HTSE electrolyzer and an SOFC are identical structures with only their mode of operation being different, the electrolyzer operating in carbon dioxide (CO₂) reduction mode or in co-electrolysis mode, i.e. with a mixture of cathode input gas composed of steam (H₂O) and carbon dioxide (CO₂). The cathode outlet mixture is then composed of hydrogen (H₂), steam (H₂O), carbon monoxide (CO) and carbon dioxide (CO₂). Referring to FIG. 4, an electrochemical cell constituting an SOFC comprises the same elements (anode 12, cathode 14, electrolyte 16) as an electrolyzer cell; however, the cell of the stack is supplied, with constant flow rates, on its anode by dihydrogen and on its cathode by dioxygen, and connected to a charge C to deliver the electric current produced. With regard to the electric current produced, of several amperes, the stack therefore has the same problems as the electrolyzer.

One solution would be to protect a copper rod (or any other metal deemed suitable in terms of electrical resistivity) by a coating to give it good resistance to oxidation, for example a chromine or alumina coating. This poses several problems. First of all, the sealing and performance of the coating must be guaranteed on the copper substrate during heating. It should be noted that as copper has a high coefficient of thermal expansion, high differential thermal expansion stresses can occur and damage the coating and/or the coating/copper interface. In addition, at the hot end of the rod, it is necessary to make an electrical connection with the stack without exposing the copper. The connection must therefore be made on the coating, without damaging it, which is technically difficult.

Another solution is to coat the copper rod with a sheath of oxidation-resistant material. In this way, the problem of resistance to differential thermal expansion stresses is solved since the two materials are not interconnected. Such an assembly (copper+stainless sheath) is already known from the prior art for other fields of application (e.g. a strong acid environment at low temperature, 50-80 °C), in particular from Chinese document CN 202608143 U which describes a copper bar that is simply threaded into a steel tube. This type of conductor is satisfactory at low temperature and with a low temperature, but it has been observed that it is not suitable as is for solid oxide systems. Indeed, the low contact between the conductive core and sheath results, given the high temperature, in the deterioration of the electrical contact between the two materials and an increase in ohmic loss. In other words, in the prior art, there is no optimized electrical conduction system adapted to a high electric current and withstanding significant thermal cycling in an oxidizing environment.

An electrical conductor adapted to currents of several hundred amperes, resistant to oxidation at high temperature and withstanding thermal cycling up to 900 °C, is known from patent application FR 3 036 840 A1. This electrical conductor comprises a rod made of a first metal material and a sheath, completely covering the rod, made of a second metal material, both being welded together using Hot Isostatic Pressing (HIP).

More specifically, this request proposes forming a rod composed of a round copper core protected by a sheath of Inconel® 600 steel tube, with a part called a “whistle” of Inconel® 600 steel which is the connection terminal, and a closure cap also of Inconel® 600 steel through which it is emptied. These parts are assembled by TIG (Tungsten Inert Gas) arc welding. The rod obtained then goes through a Hot Isostatic Pressing (HIP) process, which makes it possible, without the addition of filler metal, to perform diffusion welding of the different materials together.

However, this solution has a drawback. This is because the copper core stops at the whistle, which is made of Inconel® 600. Consequently, the current must pass through a large length of poorly electrically conductive material, which increases the electrical resistance of the current-carrying conductor.

### DESCRIPTION OF THE INVENTION

The aim of the invention is to at least partly remedy the needs mentioned above and the drawbacks relating to the embodiments of the prior art.

Thus, the object of the invention is, according to one of its aspects, an electrical conductor, comprising:
an assembly comprising:
   a main conductive core consisting of a first metal material,
   a sheath covering the main conductive core and made of a second metal material, in particular stainless or refractory, with an electrical resistivity greater than the electrical resistivity of the first metal material,
a connection pin connected to a first end of the assembly, comprising a conductive core of the connection pin and a protective housing of the connection pin, characterized in that the connection pin is at least partly made of the second metal material, in particular the protective housing being made of the second metal material, the conductive core of the connection pin being made in particular of the first metal material, and in that the conductive core of the connection pin and the main conductive core are made of a single piece.

The electrical conductor according to the invention may further comprise one or more of the following characteristics taken individually or according to all possible technical combinations.

The electrical conductor may be a rigid electrical conductor. In particular, the main conductive core may be a rigid conductive core.

“Rigid” electrical conductor means a conductor acting mechanically within a main connection and not necessarily connected to a stack, as opposed to a “soft” electrical conductor used for connection to the stack, capable of avoiding the transmission of vibrations, expansions and other parasitic movements between the stack and its environment and making it possible to make a potential electrical connection between stacks without mechanical transition. A rigid electrical conductor has sufficient rigidity to hold itself in place.

The electrical conductor may comprise a closure cap constituted at least partly of the second metal material and connected to a second end of the assembly, the closure cap including in particular a central channel for vacuum sealing.

In addition, the sheath may comprise an endpiece, at the first end of the assembly, coming into contact with the connection pin.

The conductive core of the connection pin may be inserted into the housing of the connection pin at least partly made of the second metal material. The housing and the conductive core of the connection pin may be drilled to form a passage housing a tube at least partly made of the second metal material.

The main conductive core and the conductive core of the connection pin, made of the first metal material, may be made of copper, nickel or silver and/or alloys of copper, nickel or silver, or any other metal or alloy that is good electrical conductor. In particular, any other good electrically conductive metal or alloy sensitive to oxidation at high temperatures, of around 900 °C, such as brass or bronze.

In addition, the sheath, the housing, any closure cap and any tube, made of the second metal material, may be made of stainless or refractory metal and/or of metal or refractory alloys, in particular of stainless or refractory steel, for example based on nickel, chromium or cobalt, in particular made of Inconel®, for example Inconel® 600 or 625, or any other metal or alloy resistant to oxidation at high temperatures, for example 316L stainless steel.

Furthermore, the invention further relates, according to another aspect thereof, to a method for manufacturing an electrical conductor as defined previously, characterized in that it comprises the step of manufacturing the conductive core of the connection pin by forging or die-cutting.

The method may comprise the following steps:
forging or die-cutting an end of a metal rod, in particular of cylindrical shape and circular cross-section, made of the first metal material to form the conductive core of the connection pin,
rolling the remaining portion of the metal rod to form the main conductive core and thus obtaining the main conductive core and the conductive core of the connection pin formed from a single piece made of the first metal material.

The method may further comprise the following additional steps:
inserting the main conductive core into the sheath, comprising in particular a previously machined endpiece intended to be in contact with the connection pin,
inserting the conductive core of the connection pin into the housing of the connection pin, at least partly made of the second metal material, in particular obtained by die-cutting or bending,
TIG (Tungsten Inert Gas) welding of the sheath and the housing, in particular over the entire circumference.

In addition, the method may comprise the following additional steps:
drilling the housing of the connection pin and the conductive core of the connection pin to obtain a fastening passage,
inserting a tube made of the second metal material in the passage and welding by TIG welding of the tube with the housing,
attaching a closure cap to the second end of the assembly.

The manufacturing method according to the invention may comprise the step of applying a diffusion welding cycle by Hot Isostatic Pressing (HIP).

The diffusion welding cycle by Hot Isostatic Pressing (HIP) can be carried out with the following operating conditions:
bring the assembly to a temperature between 600 °C and 1060 °C, preferably between 800 °C and 1000 °C, in particular a temperature of 920 °C,
apply on the sheath a pressure between 500 bars and 1500 bars, preferably between 800 bars and 1200 bars, in particular a pressure of 1020 bars,
applying a pressure and temperature level of a duration of 30 minutes to several hours, preferably 1 hour to 3 hours, in particular 2 hours,
letting the assembly cool down and depressurize.

Furthermore, the invention further relates, according to another aspect thereof, to the use of at least one electrical conductor as defined previously, as an electrical conductor of an electrochemical system comprising:
an enclosure for air circulation in the volume delimited by it,
an electrochemical device housed in the enclosure, comprising:
   a stack, of SOEC/SOFC type solid oxides operating at high temperature, of elementary electrochemical cells each comprising an electrolyte interposed between a cathode and an anode and connected in series between two electrical terminals, and
   said at least one electrical conductor connected to at least one of the two electrical terminals.

Moreover, the invention further relates, according to another aspect thereof, to an electrochemical system comprising:
an enclosure for air circulation in the volume delimited by it,
   an electrochemical device housed in the enclosure, comprising:
   a stack, of SOEC/SOFC type solid oxides operating at high temperature, of elementary electrochemical cells each comprising an electrolyte interposed between a cathode and an anode and connected in series between two electrical terminals, and
   at least one electrical conductor as defined previously, connected to at least one of the two electrical terminals.

### BRIEF DESCRIPTION OF THE DRAWINGS

The invention may be better understood by reading the following detailed description, non-exhaustive examples of implementation thereof, and by examining the schematic and partial figures of the appended drawing, on which:

FIG. 1 is a schematic view of an elementary electrochemical cell of an HTSE electrolyzer,

FIG. 2 is a schematic view of a stack of cells according to [FIG. 1],

FIG. 3 is a schematic view of a system incorporating a stack according to [FIG. 2],

FIG. 4 is a schematic view of an electrochemical cell of an SOFC stack,

FIG. 5 is a schematic view of an electrical conductor according to the invention,

FIG. 6 is a schematic sectional view according to plan VI-VI of [FIG. 5], and

FIG. 7 to [FIG. 17] are perspective views illustrating steps of the method for manufacturing an electrical conductor according to the invention.

In all of these figures, identical references may designate identical or similar elements.

Furthermore, the individual parts shown in the figures are not necessarily shown according to a uniform scale, to make the figures more readable.

### DETAILED DISCLOSURE OF PARTICULAR EMBODIMENTS

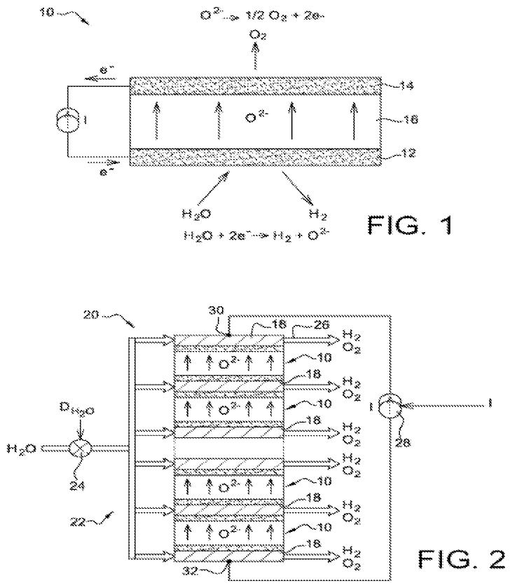

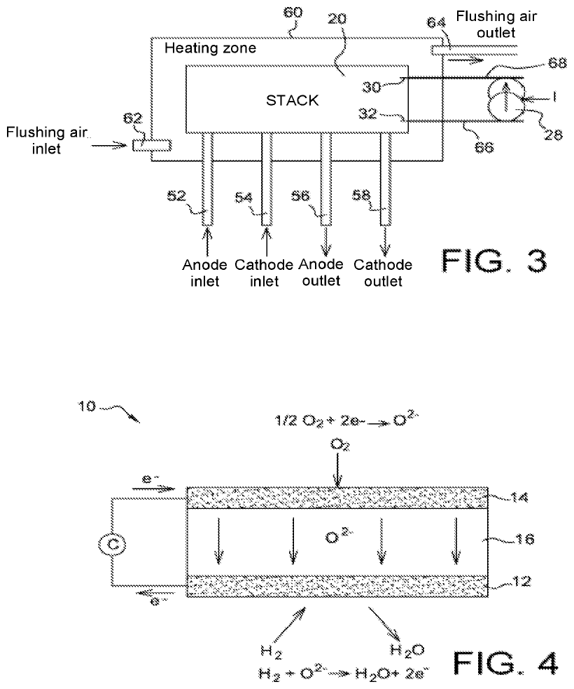

FIGS. 1 to 4 have already been described previously in the part relating to the prior art and the technical context of the invention.

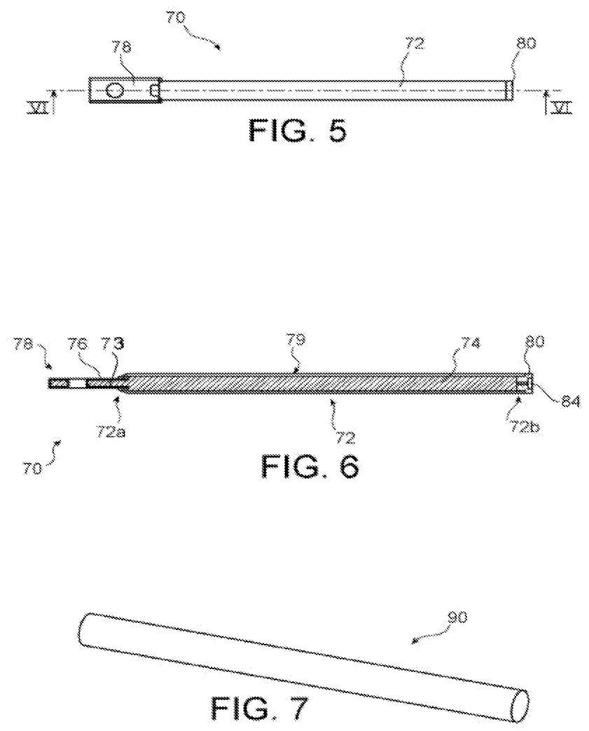

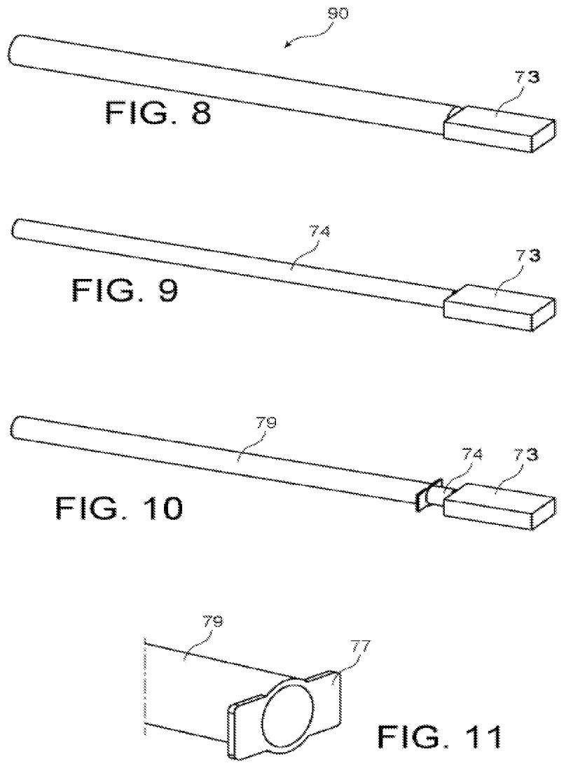

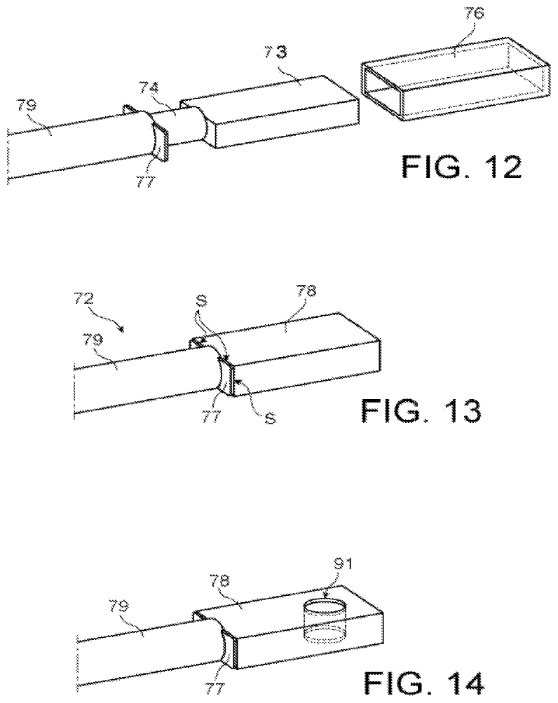

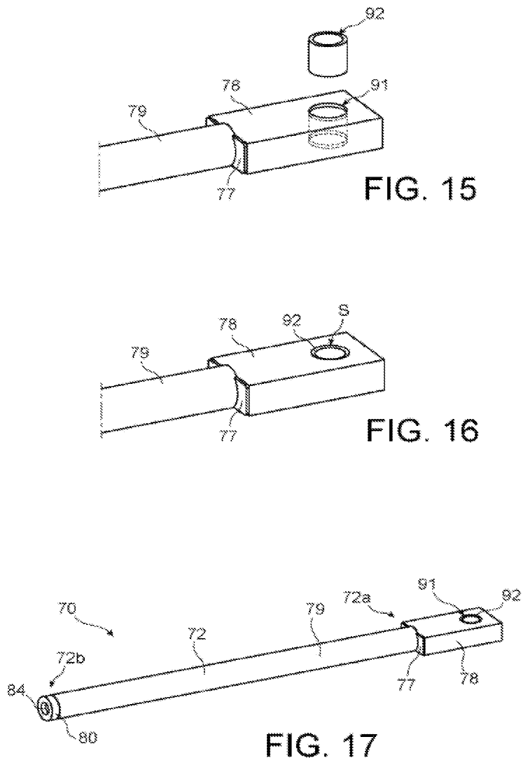

With reference to FIGS. 5 and 6, an example of an electrical conductor 70 in accordance with the invention is shown.

The electrical conductor 70 includes an assembly 72 composed of a main conductive core 74 made of a first metal material, here copper, inserted into a sheath 79, made of a second metal material, here stainless alloy, in particular made of Inconel® 600, to prevent oxidation of the first metal material subject to having reduced electrical conductivity performances, having an electrical resistivity greater than the electrical resistivity of the first metal material.

It should be noted that the main conductive core 74 is here made of copper but the invention applies to other good electrically conductive metals that are sensitive to oxidation, for example nickel, silver, brass, bronze and/or copper alloys, such as those cured by dispersoids.

In addition, the electrical conductor 70 comprises a connection pin 78, comprising a protective housing 76 and a conductive core of the connection pin 73 advantageously made of the first metal material and connected to a first end 72a of the assembly 72. In order to guarantee electrical continuity over the entire length, the conductive core of the connection pin 73 and the main conductive core 74 are made of a single piece. In other words, they form one and the same part, here made of copper, so as to obtain a one-piece current conductor.

The connection pin 78 hermetically obstructs the end 72a of the assembly 72, and thus prevents the passage of gas. It makes it possible to make an electrical connection terminal. It has a complementary shape of the plate of the electrolyzer on which the pin 78 is fixed for the electrical connection of the electrolyzer.

The shape or geometry of the connection pin 78 may be the usual shape of a terminal, as represented herein, or any other different shape, for example cylindrical, and designed to enter a hole or clamped between two half-shells interconnected with the device to be supplied.

Moreover, the electrical conductor 70 also comprises a closure cap 80 at the second end 72b of the assembly 72. This closure cap 80 makes it possible to vacuum seal the assembly 72 at its end 72b. It is for example made of the second metal material, in particular of stainless alloy, for example of Inconel® 600. The endpiece 80 makes it possible to hermetically obstruct the end 72b of the assembly 72, except for a central channel 84 that passes right through it and which is designed to connect with a vacuum sealing tube.

The conductive core of the connection pin 73 can advantageously be obtained by forging or by die-cutting, in particular from a round copper bar, for example of the CuC1 type.

Forging is a technique for obtaining a mechanical part by applying a large force to a metal bar, cold or hot, in order to force it to conform to the desired shape. Forging involves a striking device, such as a hammer, sledgehammer, jack or tapping hammer, and a support, such as an anvil or die. Forging does not allow the same tolerance margins as machining, which reserves it for parts requiring high strength but low precision such as bolting or tooling. The parts obtained are more resistant to mechanical stresses because the deformation of metals generates a large number of metallurgical phenomena, both at the microscopic and macroscopic level. Among these phenomena is notably corrugation, which itself is the cause of the fibrosity of the metal.

Die-cutting, or die-forging, consists of forming by plastic deformation after heating blanks made of alloys such as aluminum, copper, titanium, nickel alloys, etc. Die-cutting of steels is called “stamping”. Die-cutting is a forging operation performed using tools called dies, typically an upper half-die and a lower half die. The dies then carry the shape of the part in an indentation.

FIGS. 7 to 17 make it possible to illustrate, according to perspective views, steps of the method for manufacturing an electrical conductor 70 according to the invention.

Thus, FIG. 7 illustrates a metal rod 90, made of the first metal material, for example of cylindrical shape and circular cross-section, here with a diameter of 14 mm. In particular, it is a CuC1 type copper round. This metal rod 90 is designed to form the conductive core of the connection pin 73 and the main conductive core 74 made of a single piece.

Starting from this metal rod 90, the volume of the conductive core of the connection pin 73, produced by forging or here by die-cutting, will depend on the volume of the rod 90 used. In order to obtain a usual volume, i.e. around 6400 mm³ with a cross-section of 160 mm², the diameter of the rod 90 will have a cross-section equivalent to 160 mm², i.e. a diameter of around 14 mm.

After a die-cutting operation on the metal rod 90, a conductive core of the connection pin 73 is then obtained, here in a parallelepiped shape at the end of the metal rod 90.

A subsequent operation, illustrated in FIG. 9, then consists in bringing the remainder of the metal rod 90 to the desired diameter by rolling in order to obtain the main conductive core 74. A diameter of 14 mm is then changed to a diameter of 10 mm so as to subsequently allow its introduction into the sheath 79, in particular in the form of an Inconel® 600 tube with a diameter of 10/12. Between 4 and 6/10^{ths} of clearance will be required between the inner diameter of the sheath 79 and the outer diameter of the main conductive core 74 obtained by rolling.

Rolling is a plastic deformation manufacturing process. It concerns different materials such as metal or any other material in paste form such as paper or food pulp. This deformation is in particular obtained by continuous compression when passing between two counter-rotating cylinders called “rollers”.

At this stage shown in FIG. 9, the one-piece part comprising the main conductive core 74 and the conductive core of the connection pin 73, both made of copper, has therefore been obtained.

In a next step illustrated in FIG. 10, the sheath 79, here made of Inconel® 600 with a diameter of 12/10 mm, is introduced around the part formed of the main conductive core 74 and the conductive core of the connection pin 73.

The endpiece 77, shown according to an enlarged view in FIG. 11, of the sheath 79 has been previously machined in order to obtain a shape designed to fit the heel of the conductive core of the connection pin 73. This endpiece 77 may for example have a parallelepiped shape, as seen in FIG. 11, but any other shape is possible.

Subsequently, as shown in FIG. 12, a housing of the connection pin 76, here made of Inconel® 600, the thickness of which is for example between 0.5 mm and 1 mm, previously manufactured, covers the conductive core of the connection pin 73. This housing 76 is thus closed at one end and open at the other opposite end to allow the insertion of the conductive core of the connection pin 73.

The housing 76 can be obtained by die-cutting, or by bending. Advantageously, its thickness will be as thin as possible, while allowing welding, in order to oppose the least possible resistance to the electric current.

Punching is a manufacturing technique for obtaining, from a flat, thin sheet metal, an object whose shape cannot be developed. This technique may be considered for bulk manufacture of such housings 76.

At the first end 72a of the assembly 72 thus formed, the sheath 79 and the housing 76 are then welded by means of a TIG weld over the entire circumference, represented by S in FIG. 13, for example an orbital weld, with an addition of material preferably composed of the second metal material. In this way, the housing 76 is connected to the sheath 79, thanks to TIG welding over the entire periphery, so as to make the junction hermetic.

A hole or bore is then made in the conductive core of the connection pin 73 and the housing 76, as visible in FIG. 14, to create a passage 91 for the bolt that will enable the current conductor to be connected to the connection pin of the stack.

Then, as illustrated in FIG. 15, in the same logic of protecting the copper against oxidation, the passage 91 thus formed is sheathed using a tube 92, here made of stainless steel, in particular Inconel® 600, introduced into the passage 91. A TIG weld is then carried out on the circumference of this tube 92 with the housing 76 on the two faces, schematically shown by the reference S in FIG. 16. The inner diameter of this tube 92 must allow the connecting bolt between the current conductor and the stack connection pin to pass.

Finally, as illustrated by FIG. 17, the closure cap 80 is welded onto the second end 72b of the assembly 72 in order to obtain the electrical conductor 70. Thus, it is possible to vacuum seal the assembly 72 through a tube added for this purpose. A degassing tube is then added to the end 72b and the sheath 79 is emptied by pumping through the tube. Tubing can then be performed in order to permanently maintain the vacuum, allowing the tube to be hermetically and permanently sealed. Such a vacuuming step can also make it possible to perform a leak test. The rod then undergoes a HIP (Hot Isostatic Pressing) cycle as described in patent application FR 3 036 840 A1.

The stainless alloy of the sheath 79, the housing 76, the tube 92 and the closure cap 80 is chosen according to the thermal stresses to which the electrical conductor 70 is exposed. In particular, for a temperature range up to 900 °C, they can be made of Inconel® 600. In addition, the cross-sections of these elements can be chosen according to the requirements, for example in terms of current, voltage drop, etc.

The method for manufacturing such an electrical conductor 70, designed to be used as an electrical conductor for feeding a current into an electrochemical system, for example that of FIGS. 1 to 4, may further comprise, for example, one or more of the following steps:
manufacture the parts described above (core, sheath, pin),
cleaning the parts and in particular the surfaces intended for welding, i.e. the electrically conductive surfaces and the surfaces necessary for sealing the electrical conductor, by means of a detergent and/or a solvent, or any other means,
X-ray of the welds to confirm the quality of the welds from a mechanical, electrical and sealing point of view.

By comparing, in Table 1 below, the resistance obtained for a main conductive core 74 made of copper of 1 m and with a diameter of 14 mm, the resistance of a reference whistle 78 made of Inconel® 600 (embodiment according to the prior art) and the resistance of a whistle 78 (conductive core of the connection pin 73 and of the housing 76) according to the invention, it is observed that, at 800 °C, the resistance of the reference whistle 78 represents about one third of the complete current conductor for a main conductive core of only 1 m. Switching to the conductive core 73+housing 76 version of the whistle 78 makes it possible to reduce its resistance by a factor of 12 at 800 °C and even by a factor of 41 at ambient temperature (20 °C).

TABLE 1

| | | Resistance | Resistance whistle | |
|---|---|---|---|---|
| | | reference whistle | 78 (conductive core | Ratio between |
| | Resistance main | 78 in Inconel ® 600 | 73 + housing 76) | resistances reference |
| Temperature | conductive core 74 | (Ω) | thickness 0.5 mm | and invention |
| (°C) | in copper (Ω) | (8 × 20 × 38 mm) | invention(Ω) | whistles 78 |
| 20 | 112 · 10⁻⁶ | 245 · 10⁻⁶ | 5.95 · 10⁻⁶ | 41 |
| 800 | 455 · 10⁻⁶ | 268 · 10⁻⁶ | 21.9 · 10⁻⁶ | 12 |

For the results of this Table 1, the resistivity of copper is 17.24.10⁻⁹ Ω·m cold (20 °C), and 70.10⁻⁹ Ω·m at 800 °C The resistivity of Inconel® 600 is 1.03.10⁻⁶ Ω·m cold (20 °C) and 1.13.10⁻⁶ Ω·m at 800 °C.

The electrical conductor 70 obtained according to the principle of the invention is thus an electrical conductor adapted to the high temperature and high current of the stacks of SOEC/SOFC solid oxide cells. It advantageously makes it possible to limit the electrical losses at the level of the connection pin(s) 78 by avoiding any phenomenon of break in electrical continuity between the main conductive core 74 and a conductive core of the connection pin 73.

The invention may be applied to a high-temperature steam electrolyzer, a high-temperature co-electrolyzer supplied with a mixture of steam (H₂O) and carbon dioxide gas (CO₂), a high-temperature solid oxide fuel cell, a reversible system, high-temperature fuel cell and electrolyzer, “medium temperature” cell or electrolyzer, i.e. 400 °C, or PCFC (Proton Ceramic Fuel Cell), as described above.

The invention applies to the previously described systems operating at atmospheric pressure but also to pressurized systems.

Outside the technical field of solid oxide electrochemical systems, the invention applies to all fields for which there is a need for electrical conduction in a high-temperature oxidizing environment or under conditions leading to rapid degradation of electrically conductive materials.

Of course, the invention is not limited to the example embodiments that have just been described. Various modifications may be made thereto by the person skilled in the art.

1. An electrical conductor comprising:
an assembly comprising a main conductive core made of a first metal material, and a sheath covering the main conductive core and made of a second metal material, with an electrical resistivity greater than the electrical resistivity of the first metal material,
a connection pin connected to a first end of the assembly, comprising a conductive core of the connection pin and a protective housing of the connection pin,
wherein the connection pin is partly made of the second metal material, in particular the protective housing being made of the second metal material, the conductive core of the connection pin being in particular made of the first metal material, and in that the conductive core of the connection pin and the main conductive core are made of a single piece.

2. The conductor according to claim 1, further comprising:
a closure cap at least partly made of the second metal material and connected to a second end of the assembly, the closure cap comprising in particular a central channel.

3. The conductor according to claim 1, wherein the sheath comprises an endpiece, at the first end of the assembly, coming into contact with the connection pin.

4. The conductor according to claim 1, wherein the conductive core of the connection pin is inserted into the housing of the connection pin at least partly made of the second metal material.

5. The conductor according to claim 4, wherein the housing and the conductive core of the connection pin are drilled to form a passage housing a tube at least partly made of the second metal material.

6. The conductor according to claim 1, the main conductive core and the connection pin are made of copper, nickel or silver and/or alloys of copper, nickel or silver.

7. The conductor according to claim 1, wherein the sheath is made of stainless or refractory metal and/or of metal or refractory alloys, in particular of stainless or refractory steel.

8. A method for manufacturing an electrical conductor according to claim 1, comprising the step of manufacturing the conductive core of the connection pin by forging or die-cutting.

9. The method according to claim 8, further comprising the following steps:
forging or die-cutting an end of a metal rod, in particular of cylindrical shape and circular cross-section, made of the first metal material to form the conductive core of the connection pin,
rolling the remaining portion of the metal rod to form the main conductive core and thus obtaining the main conductive core and the connection pin formed of a single piece made of the first metal material.

10. The method according to claim 9, further comprising the following additional steps:
inserting the main conductive core into the sheath, comprising in particular a previously machined endpiece designed to be in contact with the connection pin,
inserting the conductive core of the connection pin into the housing of the connection pin, at least partly made of the second metal material, in particular obtained by die-cutting or bending,
TIG welding of the sheath and the housing.

11. The method according to claim 10, comprising the following additional steps:
drilling the housing of the connection pin and the conductive core of the connection pin to obtain a fastening passage,
inserting a tube made of the second metal material into the passage and TIG welding the tube with the housing,
attaching a closure cap to the second end of the assembly.

12. The method according to claim 8, further comprising the step of applying a diffusion welding cycle by Hot Isostatic Pressing.

13. The method according to claim 12, wherein the diffusion welding cycle by Hot Isostatic Pressing is carried out with the following operating conditions:
bringing the assembly to a temperature between 600 °C and 1060 °C, preferably between 800 °C and 1000 °C, in particular a temperature of 920 °C,
applying on the sheath (79) a pressure between 500 bars and 1500 bars, preferably between 800 bars and 1200 bars, in particular a pressure of 1020 bars,
applying a pressure and temperature level of a duration of 30 minutes to several hours, preferably 1 hour to 3 hours, in particular 2 hours,
letting the assembly cool down and depressurize.

14. Use of at least one electrical conductor according to claim 1, as an electrical conductor of an electrochemical system comprising:
an enclosure for circulating air in the volume delimited by it,
an electrochemical device housed in the enclosure, comprising:
a stack, with solid oxides of the SOEC/SOFC type operating at high temperature, of elementary electrochemical cells each comprising an electrolyte interposed between a cathode and an anode and connected in series between two electrical terminals, and
said at least one electrical conductor connected to at least one of the two electrical terminals.

15. An electrochemical system comprising:
an enclosure for circulating air in the volume delimited by it,
an electrochemical device housed in the enclosure, comprising:
a stack, with solid oxides of the SOEC/SOFC type operating at high temperature, of elementary electrochemical cells each comprising an electrolyte interposed between a cathode and an anode and connected in series between two electrical terminals, and
at least one electrical conductor according to claim 1, connected to at least one of the two electrical terminals.
